(19) United States
(12) Patent Application Publication
(10) Pub. No.: US 2024/0166157 A1
(43) Pub. Date: May 23, 2024

(54) AIRBAG DEVICE

(71) Applicant: TOYODA GOSEI CO., LTD., Kiyosu-shi (JP)

(72) Inventors: Yuya SUZUKI, Aichi-ken (JP); Motoyuki TANAKA, Aichi-ken (JP)

(21) Appl. No.: 18/504,310

(22) Filed: Nov. 8, 2023

(30) Foreign Application Priority Data
Nov. 18, 2022 (JP) 2022-185026

(51) Int. Cl. B60R 21/215; B60R 21/2338

(52) U.S. Cl. CPC B60R 21/215; B60R 21/2338; B60R 2021/23382

(57) ABSTRACT

An airbag device for an occupant seat mounted on a vehicle includes an airbag case accommodated inside an instrument panel of the vehicle and having an opening formed toward the occupant seat, an inflator disposed in the airbag case and configured to inject gas, and a bag portion having a peripheral wall formed of a flexible sheet material and stored in the airbag case, the bag portion being configured to inflate and deploy toward the occupant seat from the opening by the gas injected from the inflator. The peripheral wall is provided with a hole configured to discharge the gas from inside the bag portion in an execution state of the inflation and deployment. The hole is formed on the peripheral wall to be located in a vicinity of the opening in a deployment completed state in which the inflation and deployment is completed.

### CROSS-REFERENCE TO RELATED APPLICATIONS

This application is based on and claims priority under 35 USC 119 from Japanese Patent Application No. 2022-185026 filed on Nov. 18, 2022, the entire content of which is incorporated herein by reference.

### TECHNICAL FIELD

The present disclosure relates to an airbag device.

### BACKGROUND ART

Various types of airbag devices have been proposed for protecting an occupant seated in a passenger seat when a collision occurs in a vehicle. For example, JP2011-056993A discloses an airbag device for a passenger seat that can complete inflation and deployment at an early stage.

However, in the case of the airbag device having a configuration in which an opening of an airbag case faces the passenger seat as disclosed in JP2011-056993A, time from the start of inflation of the airbag to the contact between the airbag and the occupant in the passenger seat is short compared with a configuration in which the opening of the airbag case faces upward, which accordingly demands a technique of quickly lowering the internal pressure of the airbag after inflation and deployment.

### SUMMARY OF INVENTION

The present disclosure can be implemented by the following aspects.

(1) According to an aspect of the present disclosure, there is provided an airbag device for an occupant seat mounted on a vehicle. The airbag device according to this aspect includes: an airbag case accommodated inside an instrument panel of the vehicle and having an opening formed toward the occupant seat; an inflator disposed in the airbag case and configured to inject gas; and a bag portion having a peripheral wall formed of a flexible sheet material and stored in the airbag case, the bag portion being configured to inflate and deploy toward the occupant seat from the opening by the gas injected from the inflator, in which the peripheral wall is provided with a hole configured to discharge the gas from inside the bag portion in an execution state of the inflation and deployment, and the hole is formed on the peripheral wall to be located in a vicinity of the opening in a deployment completed state in which the inflation and deployment is completed.

According to the airbag device in this aspect, the peripheral wall of the bag portion is formed with the hole located in the vicinity of the opening in the deployment completed state. Accordingly, gas can be discharged to the outside of the bag portion at an early stage in the execution state of the inflation and deployment and the internal pressure of the bag portion can be quickly lowered compared with a configuration in which the hole is formed in a position away from the opening.

(2) In the airbag device according to the aspect described above, the hole may be located in the vicinity of the opening to be provided on the peripheral wall at a front side of the vehicle in the deployment completed state when the bag portion is divided into two parts in a front-rear direction of the vehicle as viewed in a vehicle width direction.

According to the airbag device in this aspect, the hole is located in the vicinity of the opening to be provided on the peripheral wall at the front side of the vehicle in the deployment completed state when the bag portion is divided into two parts in the front-rear direction of the vehicle as viewed in the vehicle width direction. Accordingly, gas in the bag portion can be discharged in a position close to the opening compared with a configuration in which the hole is formed on the rear side of the vehicle when the bag portion is divided into two parts in the front-rear direction of the vehicle as viewed in the vehicle width direction. Accordingly, gas supplied from the inflator can be discharged to the outside of the bag portion at an early stage, and the internal pressure of the bag portion in the execution state of the inflation and deployment can be quickly lowered.

(3) In the airbag device according to the above aspect, the hole may be located in the vicinity of the opening to be formed on the peripheral wall at a position where a distance from the opening to the hole in the front-rear direction is equal to or less than a half of a dimension of the bag portion in the front-rear direction in the deployment completed state as viewed in the vehicle width direction.

According to the airbag device in this aspect, the hole is formed on the peripheral wall at the position where the distance from the opening to the hole in the front-rear direction is equal to or less than the half of the dimension of the bag portion in the front-rear direction in the deployment completed state as viewed in the vehicle width direction. Accordingly, gas in the bag portion can be discharged in a position close to the opening compared with a configuration in which the hole is formed on the peripheral wall at a distance of more than the half of the dimension of the bag portion in the front-rear direction. Accordingly, gas supplied from the inflator can be discharged to the outside of the bag portion at an early stage, and the internal pressure of the bag portion in the execution state of the inflation and deployment can be quickly lowered.

(4) In the airbag device according to the above aspect, the hole may be located in the vicinity of the opening to be formed on the peripheral wall such that at least a part of the hole is located below an upper end of the opening in the deployment completed state.

According to the airbag device in this aspect, the hole is located in the vicinity of the opening to be formed on the peripheral wall such that at least a part of the hole is located below the upper end of the opening in the deployment completed state. Accordingly, gas in the bag portion can be discharged in a position close to the opening compared with a configuration in which the hole is located above the upper end of the opening. Accordingly, gas supplied from the inflator can be discharged to the outside of the bag portion at an early stage, and the internal pressure of the bag portion in the execution state can be quickly lowered.

(5) The airbag device according to the above aspect may further include a tether having a one end and an other end and installed inside the bag portion, in which the one end is connected to an inner surface of the peripheral wall to be located at an upper side inside the bag portion in the deployment completed state, and the other end is connected to a periphery of the hole in the bag portion. The tether may close the hole in the deployment completed state by pulling a periphery of a portion connected with the tether in the bag portion into the bag portion.

According to the airbag device in this aspect, the tether closes the hole in the deployment completed state by pulling the periphery of the portion connected with the tether in the bag portion into the bag portion. Accordingly, gas can be discharged from the hole in the execution state of the inflation and deployment, and can be prevented from being discharged in the deployment completed state. Accordingly, the internal pressure of the bag portion in the execution state of the inflation and deployment can be quickly lowered, and the internal pressure of the bag portion in the deployment completed state can be prevented from being excessively low. The one end of the tether is connected to the inner surface of the peripheral wall to be located on the upper side inside the bag portion. Accordingly, time until the tether changes from a relaxed state to a tension state, that is, time until the hole is closed can be made long compared with a configuration in which the one end is located on a lower side inside the bag portion. Accordingly, time for the hole in the execution state to discharge gas can be made long, and the internal pressure of the bag portion in the execution state can be further lowered. Generally, the bag portion inflates more on an upper side than on a lower side during inflation and deployment. This is because the bag portion cannot largely inflate in the vicinity of the lower side due to knees of the occupant, whereas there is a large area for the bag portion to receive the occupant on the upper side from the knees of the occupant. For this reason, a completion timing of the inflation and deployment of the bag portion is later on the upper side than on the lower side. For this reason, time until the hole is closed can be made long since the one end of the tether is connected to the inner surface of the peripheral wall to be located at the upper side inside the bag portion as described above.

(6) In the airbag device according to the above aspect, the one end of the tether may be connected to the inner surface to be located at an uppermost portion inside the bag portion in the deployment completed state.

According to the airbag device in this aspect, the one end of the tether is connected to the inner surface to be located at the uppermost portion inside the bag portion in the deployment completed state. Accordingly, time until the tether changes from a relaxed state to a tensed state, that is, time until the hole is closed can be made long compared with a configuration in which the one end of the tether is connected to the bag portion other than the uppermost portion. Accordingly, time for the hole in the execution state to discharge gas can be made long, and the internal pressure of the bag portion in the execution state can be further lowered.

### BRIEF DESCRIPTION OF DRAWINGS

Exemplary embodiment(s) of the present invention will be described in detail based on the following figures, wherein:

FIG. 1 illustrates a schematic configuration of an airbag device according to an embodiment of the present disclosure;

FIG. 2 illustrates a schematic configuration of the airbag device according to the embodiment of the present disclosure;

FIG. 3 illustrates a schematic configuration of the airbag device according to the embodiment of the present disclosure;

FIG. 4 is a plan view of a pair of restraining surface sheets;

FIG. 5 is a plan view of a pair of side surface sheets;

FIG. 6 is a schematic view of a hole in an execution state; and

FIG. 7 is a schematic view of the hole in a deployment completed state.

### DESCRIPTION OF EMBODIMENTS

### A. Embodiments

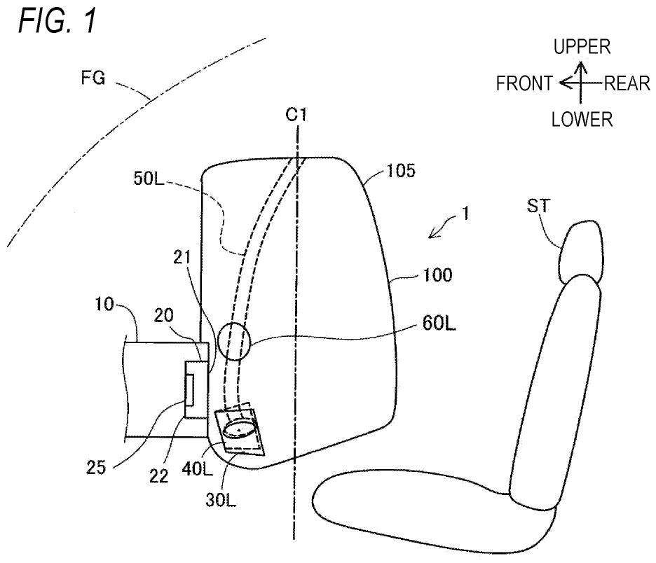

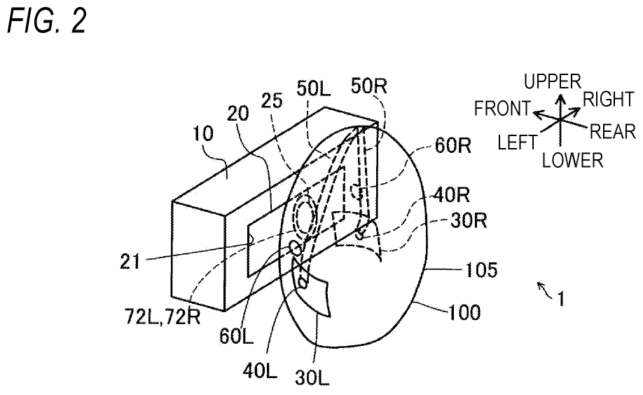

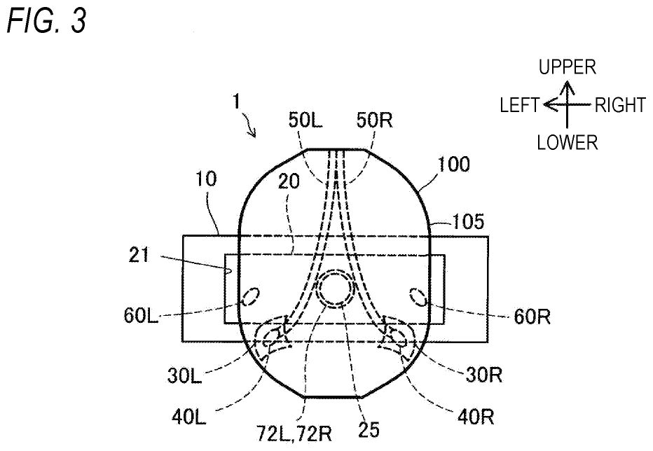

FIGS. 1 to 3 illustrate a schematic configuration of an airbag device 1 according to an embodiment of the present disclosure. FIG. 1 is a schematic view of the airbag device 1 as viewed in a vehicle width direction of a vehicle on which the airbag device 1 is mounted. FIG. 2 is a schematic view of the airbag device 1 as viewed from a left rear side. FIG. 3 is a schematic view of the airbag device 1 as viewed from a passenger seat ST side of the vehicle. In the drawings and the following description, a “front-rear direction” indicates a front-rear direction when a traveling direction of the vehicle is defined as “front”, “left and right (lateral) direction” indicates a left-right direction (width direction) of the vehicle, and an “upper-lower direction” indicates a height direction of the vehicle. FIGS. 1 to 3 illustrate a state in which the inflation and deployment of a bag portion 100 is completed (a deployment completed state to be described later). In FIGS. 2 and 3, a passenger seat ST is omitted.

The airbag device 1 according to the present embodiment is disposed in front of the passenger seat ST of the vehicle. The airbag device 1 protects an occupant in the passenger seat ST from an impact when a collision occurs in the vehicle or when a collision is predicted. The airbag device 1 includes an airbag case 20, an inflator 25, and the bag portion 100.

The airbag case 20 is accommodated inside an instrument panel 10 of the vehicle, and has a bottomed box shape. The airbag case 20 is formed with an opening 21 toward the passenger seat ST. In other words, the opening 21 is formed in a direction not toward a windshield FG. When the bag portion 100 is stored, the opening 21 is closed by a door portion (not illustrated).

The inflator 25 injects gas into the bag portion 100. The inflator 25 is disposed in the airbag case 20, and is fixed to a bottom portion 22 of the airbag case 20 together with a retainer (not illustrated).

The bag portion 100 has a bag shape. The bag portion 100 is normally stored in the airbag case 20, and pushes the door portion (not illustrated) open and inflates and deploys toward the passenger seat ST when being injected with gas by the inflator 25. The airbag device 1 has states including an “execution state” and a “deployment completed state”. The “execution state” refers to a state in which the bag portion 100 is inflating and deploying by the injection of gas. The “deployment completed state” refers to a state in which the inflation and deployment of the bag portion 100 by the injection of gas is completed.

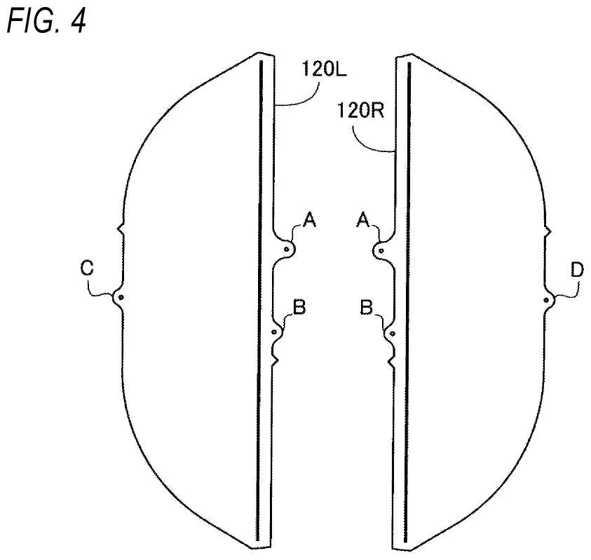

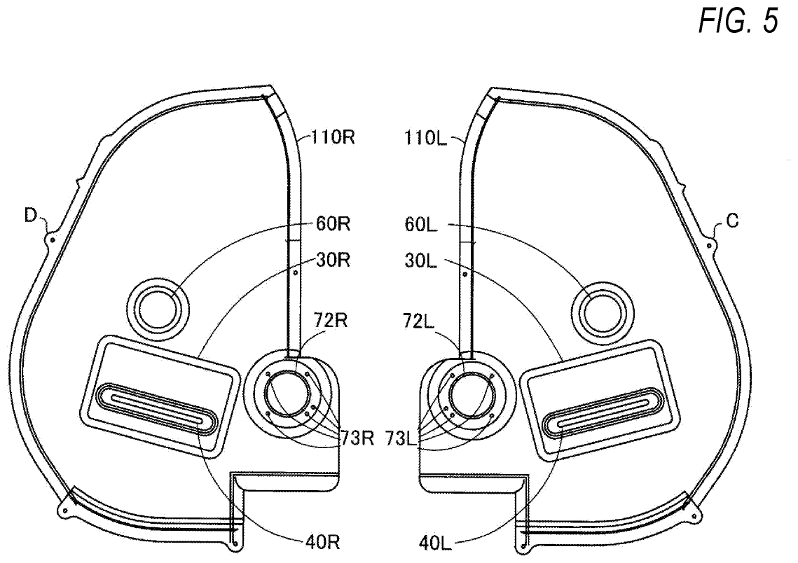

The bag portion 100 has a peripheral wall 105 formed of a flexible sheet material. The flexible sheet material is, for example, a woven fabric made of polyamide. FIG. 4 is a plan view of a pair of restraining surface sheets 120L, 120R. FIG. 5 is a plan view of a pair of side surface sheets 110L, 110R. The peripheral wall 105 according to the present embodiment is implemented by a plurality of sheets, that is, the pair of restraining surface sheets 120L, 120R and the pair of side surface sheets 110L, 110R. As illustrated in FIG. 4, the left restraining surface sheet 120L and the right restraining surface sheet 120R are bilaterally symmetrical to each other. The pair of restraining surface sheets 120L, 120R are portions of the peripheral wall 105 that face the occupant in the passenger seat ST in the deployment completed state. The left restraining surface sheet 120L and the right restraining surface sheet 120R are sewn together such that sewn portions A and sewn portions B respectively overlap with each other at a central portion in FIG. 4. As illustrated in FIG. 5, the left side surface sheet 110L and the right side surface sheet 110R are symmetrical to each other. The pair of side surface sheets 110L, 110R are located in the left-right direction when the bag portion 100 is in the deployment completed state. The left side surface sheet 110L and the right side surface sheet 110R are sewn such that inflator insertion holes 72L, 72R overlap with each other. As illustrated in FIGS. 4 and 5, the pair of restraining surface sheets 120L, 120R and the pair of side surface sheets 110L, 110R are sewn such that a sewn portion C of the left restraining surface sheet 120L overlaps with the sewn portion C of the left side surface sheet 110L and a sewn portion D of the right restraining surface sheet 120R overlaps with the sewn portion D of the right side surface sheet 110R. As illustrated in FIG. 5, the pair of side surface sheets 110L, 110R respectively include the inflator insertion holes 72L, 72R, discharge outlets 60L, 60R, and tether attachment portions 30L, 30R.

The inflator insertion holes 72L, 72R are openings into which an exhaust outlet of the inflator 25 is inserted. The inflator insertion holes 72L, 72R are provided with a plurality of attachment holes 73L, 73R around. Fixing members such as bolts are inserted into the plurality of attachment holes 73L, 73R, and the retainer, the bag portion 100, and the inflator 25 are fixed to the airbag case 20.

The discharge outlets 60L, 60R are openings provided in the vicinity of centers of the pair of side surface sheets 110L, 110R. Gas in the inflated and deployed bag portion 100 is discharged to the outside of the bag portion 100 through the discharge outlets 60L, 60R. Since the excess gas is discharged through the discharge outlets 60L, 60R, the bag portion 100 can receive the occupant at an appropriate pressure.

Tethers 50L, 50R to be described later are connected to the tether attachment portions 30L, 30R by sewing. The tether attachment portions 30L, 30R are formed with elongated holes 40L, 40R. As illustrated in FIG. 1, the holes 40L, 40R are located in the vicinity of the opening 21 in the deployment completed state of the bag portion 100. A positional relationship of the holes 40L, 40R will be described later. The tether attachment portions 30L, 30R have a double structure in which sheet members are attached from inside for reinforcement. As illustrated in FIGS. 1 to 3, the tethers 50L, 50R have an elongated sheet-like external shape and are installed in the bag portion 100. Similarly to the peripheral wall 105, the tethers 50L, 50R are formed of a flexible sheet material. Each one end of each of the tethers 50L, 50R is connected to an inner surface of the peripheral wall 105 to be located at an upper side in the bag portion 100 in the deployment completed state of the bag portion 100. The “upper side” refers to a portion located at an upper side when the bag portion 100 is divided into two parts in a vertical direction. In the present embodiment, 50L, 50R are connected to an uppermost portion of the bag portion 100. The “uppermost portion” in the present embodiment has a broad meaning including not only an uppermost portion in the vertical direction but also a portion having an error of substantially −3%. The other end of each of the tethers 50L, 50R is connected to a periphery of a respective one of the holes 40L, 40R. Assuming that 0% means a position of an uppermost point of the bag portion 100, the portion having the error of “−3%” is positioned below at a rate of 3% out of 100%, which means a size of the bag portion in the vertical direction, from the uppermost point.

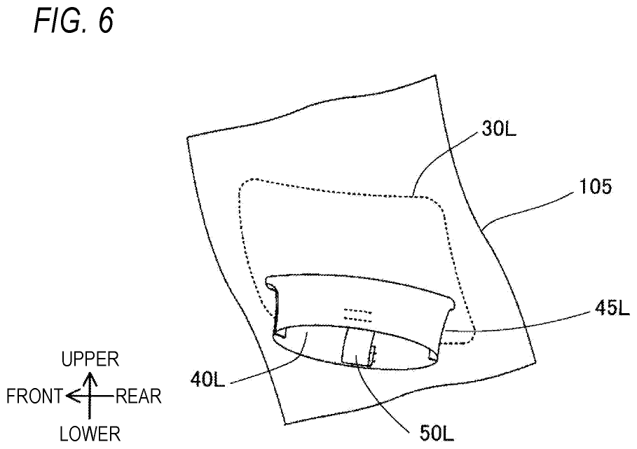

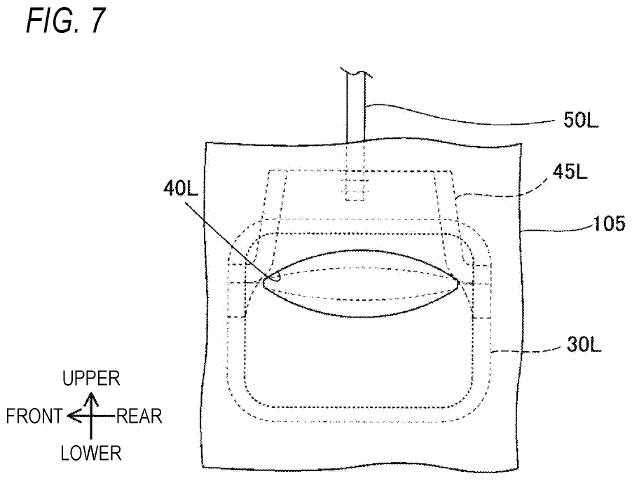

The holes 40L, 40R according to the present embodiment discharge gas from inside the bag portion 100 in the execution state. In the deployment completed state, the tethers 50L, 50R close the holes 40L, 40R by pulling portions connecting the bag portion 100 and the tethers 50L, 50R, that is, the tether attachment portions 30L, 30R, into the bag portion 100. FIG. 6 is a schematic view of the hole 40L in the execution state. FIG. 7 is a schematic view of the hole 40L in the deployment completed state. In FIGS. 6 and 7, only the periphery of the hole 40L on the left side surface sheet 110L is illustrated, and other portions are omitted. As illustrated in FIG. 6, a tubular portion 45L protruding outward from the bag portion 100 is formed around the hole 40L. The tubular portion 45L may be formed integrally with the peripheral wall 105, or may be formed of a sheet member and sewn to the peripheral wall 105. The other end of the tether 50L is connected to an inner peripheral surface of the tubular portion 45L. As illustrated in FIGS. 1 to 3, since the one end of the tether 50L is connected to be located at the uppermost portion in the bag portion 100 in the deployment completed state, the tether 50L is in a bent and relaxed state in the execution state in which the bag portion 100 is inflating and deploying. In this state, the hole 40L allows the inside and the outside of the bag portion 100 to communicate with each other, and gas in the bag portion 100 can be discharged to the outside.

On the other hand, in the deployment completed state, the tether 50L is pulled by the inner surface of the inflated and deployed bag portion 100, and is thereby more tensed. At this time, as illustrated in FIG. 7, the portion connected with the tether 50L in the tubular portion 45L is drawn into the bag portion 100 together with the tubular portion 45L. In this way, the hole 40L is closed. Here, “the hole 40L is closed” has a wide meaning including not only a state in which the hole 40L is completely closed, but also a state in which there is a small hole through which gas can flow slightly.

As described above, the hole 40L can quickly reduce the internal pressure of the bag portion 100 by discharging gas from inside the bag portion 100 in the execution state. Since the hole 40L is closed in the deployment completed state, the internal pressure of the bag portion 100 can be prevented from being excessively low. Although the left side surface sheet 110L has been described with reference to FIGS. 6 and 7, the right side surface sheet 110R has the same structure and exhibits the same effect.

The holes 40L, 40R are located in the vicinity of the opening 21 in the deployment completed state. For this reason, gas supplied from the inflator 25 is discharged to the outside of the bag portion 100 at an early stage compared with a configuration in which the holes 40L, 40R are located in positions away from the opening 21. Accordingly, the internal pressure of the bag portion 100 in the execution state can be quickly lowered.

As illustrated in FIG. 1, the holes 40L, 40R according to the present embodiment are formed on the peripheral wall 105 to be located at a front side of the vehicle when the bag portion 100 is divided into two parts in the front-rear direction of the vehicle as viewed in the vehicle width direction. An axis Cl in FIG. 1 is a center line of the bag portion 100 as viewed in the vehicle width direction. The center here is the center of a length passing through the center of the opening 21 among lengths of the bag portion 100 in a direction parallel to the vehicle front-rear direction as viewed in the vehicle width direction. Since the holes 40L, 40R are formed in such positions, the holes 40L, 40R are formed in positions close to the opening 21 compared with a configuration in which the holes 40L, 40R are formed on a rear side of the vehicle when the bag portion 100 is divided into two parts in the front-rear direction of the vehicle as viewed in the vehicle width direction. Accordingly, gas supplied from the inflator 25 can be discharged to the outside of the bag portion 100 at an early stage, and the internal pressure of the bag portion 100 in the execution state can be quickly lowered.

As illustrated in FIG. 1, the holes 40L, 40R according to the present embodiment are formed on the peripheral wall 105 to be located below an upper end of the opening 21 in the deployment completed state. Since the holes 40L, 40R are formed in such positions, the holes 40L, 40R are formed in positions close to the opening 21 compared with a configuration in which the holes 40L, 40R are located above the upper end of the opening 21. Accordingly, gas supplied from the inflator 25 can be discharged to the outside of the bag portion 100 at an early stage, and the internal pressure of the bag portion 100 in the execution state can be quickly lowered. The same effect is achieved not only when the entire holes 40L, 40R are located below the upper end of the opening 21, but also when at least a part of the holes 40L, 40R are located below the upper end of the opening 21.

According to the airbag device 1 in the first embodiment described above, the peripheral wall 105 of the bag portion 100 is formed with the holes 40L, 40R located in the vicinity of the opening 21 in the deployment completed state. Accordingly, gas can be discharged to the outside of the bag portion 100 at an early stage in the execution state of the inflation and deployment and the internal pressure of the bag portion 100 can be quickly lowered compared with a configuration in which the holes 40L, 40R are formed in positions away from the opening 21.

The holes 40L, 40R are located in the vicinity of the opening 21 to be provided on the peripheral wall 105 at the front side of the vehicle in the deployment completed state when the bag portion 100 is divided into two parts in the front-rear direction of the vehicle as viewed in the vehicle width direction. Accordingly, gas in the bag portion 100 can be discharged in positions close to the opening 21 compared with a configuration in which the holes 40L, 40R are formed on the rear side of the vehicle when the bag portion 100 is divided into two parts in the front-rear direction of the vehicle as viewed in the vehicle width direction. Accordingly, gas supplied from the inflator 25 can be discharged to the outside of the bag portion 100 at an early stage, and the internal pressure of the bag portion 100 in the execution state can be quickly lowered.

The holes 40L, 40R are located in the vicinity of the opening 21 to be formed on the peripheral wall 105 such that at least a part of the holes 40L, 40R is located below the upper end of the opening 21 in the deployment completed state. Accordingly, the holes 40L, 40R can be formed in positions close to the opening 21 compared with a configuration in which the holes 40L, 40R are located above the upper end of the opening 21. Accordingly, gas supplied from the inflator 25 can be discharged to the outside of the bag portion 100 at an early stage, and the internal pressure of the bag portion 100 in the execution state can be quickly lowered.

The tethers 50L, 50R close the holes 40L, 40R in the deployment completed state by pulling peripheries of the portions connected with the tethers 50L, 50R in the bag portion 100 into the bag portion 100. Accordingly, gas is discharged from the holes 40L, 40R in the execution state, and is prevented from being discharged in the deployment completed state. Accordingly, the internal pressure of the bag portion 100 in the execution state can be quickly lowered, and the internal pressure of the bag portion 100 in the deployment completed state can be prevented from being excessively low.

The one end of each of the tethers 50L, 50R is connected to the inner surface to be located at the uppermost portion in the bag portion 100 in the deployment completed state. Accordingly, time until the tethers 50L, 50R change from a relaxed state to a tensed state, that is, time until the holes 40L, 40R are closed can be made long compared with a configuration in which the one end of each of the tethers 50L, 50R is connected to the bag portion 100 other than the uppermost portion. Accordingly, time for the holes 40L, 40R in the execution state to discharge gas can be made long, and the internal pressure of the bag portion 100 in the execution state can be further lowered. Generally, the bag portion 100 inflates more on an upper side than on a lower side during inflation and deployment. This is because the bag portion 100 cannot largely inflate in the vicinity of the lower side due to knees of the occupant, whereas there is a large area for the bag portion 100 to receive the occupant on the upper side from the knees of the occupant. For this reason, a completion timing of the inflation and deployment of the bag portion 100 is later on the upper side than on the lower side. For this reason, time until the holes 40L, 40R are closed can be made long since the one end of each of the tethers 50L, 50R is connected to the inner surface of the peripheral wall 105 to be located at the uppermost portion inside the bag portion as described above.

Since the holes 40L, 40R are elongated holes, an opening area can be small compared with a configuration of round holes or square holes. For this reason, when the holes 40L, 40R are closed by the tethers 50L, 50R, the holes 40L, 40R can be closed quickly.

### B. Other Embodiments

(B1) In the above-described embodiment, the holes 40L, 40R may be located in the vicinity of the opening 21 to be formed on the peripheral wall 105 at a position where a distance from the opening 21 to the holes 40L, 40R in the front-rear direction is equal to or less that a half of a dimension of the bag portion 100 in the front-rear direction in the deployment completed state as viewed in the vehicle width direction. According to such a configuration, the holes 40L, 40R are formed close to the opening 21 compared with a configuration in which the holes 40L, 40R are formed on the peripheral wall 105 at a distance of more than the half of the dimension of the bag portion 100 in the front-rear direction. Accordingly, gas supplied from the inflator 25 is discharged to the outside of the bag portion 100 at a relatively early stage, so that the internal pressure of the bag portion 100 in the execution state can be quickly reduced.

(B2) In the above-described embodiment, the one end of each of the tethers 50L, 50R is connected to the inner surface of the peripheral wall 105 to be located at the uppermost portion in the bag portion 100 in the deployment completed state, and the present disclosure is not limited thereto. The one end of each of the tethers 50L, 50R may be connected to a freely selected upper position in the bag portion 100 in the deployment completed state. According to this configuration, it is also possible to extend the time until the tethers 50L, 50R change from the relaxed state to the tensed state, that is, the time until the holes 40L, 40R are closed. Accordingly, time for the holes 40L, 40R in the execution state to discharge gas can be made long, and the internal pressure of the bag portion 100 in the execution state can be further lowered.

(B3) In the above-described embodiment, the airbag device 1 is used in the passenger seat ST of the vehicle, and the present disclosure is not limited thereto. The airbag device 1 may be disposed in any occupant seat in the vehicle. The airbag device 1 may be used, for example, in an occupant seat of an autonomous driving vehicle that does not include a steering device.

(B4) In the above-described embodiment, the holes 40L, 40R are closed by the tethers 50L, 50R in the deployment completed state. Alternatively, the tethers 50L, 50R may not be provided and the holes 40L, 40R may not be closed in the deployment completed state. According to this configuration, gas is discharged to the outside of the bag portion 100 through the holes 40L, 40R in the execution state, and thus the internal pressure of the bag portion 100 can be quickly lowered. In this configuration, the discharge outlets 60L, 60R may be omitted.

(B5) In the above-described embodiment, the holes 40L, 40R are elongated holes, and may be holes having a freely selected planar shape.

(B6) In the above-described embodiment, the other end of each of the tethers 50L, 50R is connected to the inner peripheral surface of the tubular portion 45L, and the present disclosure is not limited thereto. The other end of each of the tethers 50L, 50R may be connected to the periphery of a respective one of the holes 40L, 40R on an outer surface or the inner surface of the bag portion 100. With this configuration as well, the holes 40L, 40R can be closed by the tethers 50L, 50R in a tensed state when the deployment is completed. The bag portion 100 may not include the tubular portion 45L.

(B7) In the above-described embodiment, tethers may be provided at both ends in the left-right direction or the front-rear direction inside the bag portion 100. According to this configuration, the amount of inflation and deployment of the bag portion 100 in the left-right direction or the front-rear direction is restricted in the execution state. Accordingly, a position of the bag portion 100 in the deployment completed state can be controlled to an appropriate position for protecting the occupant.

The present disclosure is not limited to the above-described embodiments, and can be implemented by various configurations without departing from the gist of the present disclosure. For example, the technical features in the embodiments corresponding to the technical features in the aspects described in the summary of the invention can be replaced or combined as appropriate to solve a part or all of the above-described problems or to achieve a part or all of the above-described effects. The technical features can be appropriately deleted unless being described as necessary in the present specification.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An airbag device for an occupant seat mounted on a vehicle, the airbag device comprising:
an airbag case accommodated inside an instrument panel of the vehicle and having an opening formed toward the occupant seat;
an inflator disposed in the airbag case and configured to inject gas; and
a bag portion having a peripheral wall formed of a flexible sheet material and stored in the airbag case, the bag portion being configured to inflate and deploy toward the occupant seat from the opening by the gas injected from the inflator,
wherein the peripheral wall is provided with a hole configured to discharge the gas from inside the bag portion in an execution state of the inflation and deployment, and
the hole is formed on the peripheral wall to be located in a vicinity of the opening in a deployment completed state in which the inflation and deployment is completed.

2. The airbag device according to claim 1,
wherein the hole is located in the vicinity of the opening to be provided on the peripheral wall at a front side of the vehicle in the deployment completed state when the bag portion is divided into two parts in a front-rear direction of the vehicle as viewed in a vehicle width direction.

3. The airbag device according to claim 2,
wherein the hole is located in the vicinity of the opening to be formed on the peripheral wall at a position where a distance from the opening to the hole in the front-rear direction is equal to or less than a half of a dimension of the bag portion in the front-rear direction in the deployment completed state as viewed in the vehicle width direction.

4. The airbag device according to claim 1,
wherein the hole is located in the vicinity of the opening to be formed on the peripheral wall such that at least a part of the hole is located below an upper end of the opening in the deployment completed state.

5. The airbag device according to claim 4, further comprising:
a tether having a one end and an other end and installed inside the bag portion, wherein the one end is connected to an inner surface of the peripheral wall to be located at an upper side inside the bag portion in the deployment completed state, and the other end is connected to a periphery of the hole in the bag portion,
wherein the tether closes the hole in the deployment completed state by pulling a periphery of a portion connected with the tether in the bag portion into the bag portion.

6. The airbag device according to claim 5,
wherein the one end of the tether is connected to the inner surface to be located at an uppermost portion inside the bag portion in the deployment completed state.
